(19) United States
(12) Patent Application Publication
(10) Pub. No.: US 2004/0134036 A1
(43) Pub. Date: Jul. 15, 2004

(54) Pivot device for a hinged cover

(76) Inventor: William Home, Taipei City (TW)

Correspondence Address: Leong C. Lei, PMB#1008, 1867 Ygnacio Valley Road, Walnut Creek, CA, 94598-3214, US

(21) Appl. No.: 10/342,383

(22) Filed: Jan. 15, 2003

(51) Int. Cl. E05D 15/02

(52) U.S. Cl. 16/363

(57) ABSTRACT

A pivotal device for a hinged cover comprises a securing plate, a driven plate, a plurality of urging elements and a rotating shaft characterized in that a plate face formed from stacking the securing plate and the driven plate is provided with a cam block at the center thereof, the center of the plate face is provided with shaft hole allowing the insertion of the rotating shaft so as to mount the plate center of the securing plate and the driven plate, the external surrounding of the plate face is evenly mounted with a plurality of vertically extended urging elements having a thickness thinner than that of the cam block, the two lateral wall of a container having pivotal points are provided with an engaging hole for engaging with the cam block of the securing plate and the container having a lifting cover provided with two lateral wall corresponding to the urging element are provided with a mounting hole, and the pivot point at the two lateral wall of the lifting cover are provided with an engaging hole for mounting with cam block of the driven plate, the two lateral wall of the lifting cover corresponding to the urging element of the driven plate is provided with a mounting hole for closely mounting of the urging element.

### BACKGROUND OF THE INVENTION

(a) Technical Field of the Invention

The present invention relates to a pivot device, and in particular, to a pivot device used for a hinged cover mounted at the lateral wall of the cover. A plurality of urging elements are employed to evenly distribute the exertion force generated in the course of rotation of the hinged cover.

(b) Description of the Prior Art

Pivot device is normally used in container or casserole having a rotatable cover. As shown in FIG. 1, there is shown a conventional pivot device for use in a grilling plate 20 having a lifting cover 10 for covering food on the grilling plate 20. As shown in the drawing, a peg 30 is inserted into the lifting cover 10 at one lateral edge and the lateral side of the grilling plate 20. The peg 30 can be a screw or the like. The peg 30 is used as a shaft for rotation. The conventional pivot device has the following drawbacks.

(1) A single, tiny shaft point. Frequent rotating of the cover causes a force being exerted onto the shaft point. This will enlarge the pivotal hole of the device for the insertion of the shaft and the peg may be dislocated after a period of use.

(2) Deformation of the peg. The shear force exerted to the peg will cause the peg to deform.

(3) Fully open of the cover without a blockage to the back end of the cover will damage the wall of the grilling plate and the cover.

Accordingly, it is an object of the present invention to provide an improved pivotal device for a hinged cover which mitigates the above-mentioned drawbacks.

### SUMMARY OF THE INVENTION

Accordingly, it is an object of the present invention to provide an improved pivotal device for a hinged cover having a securing plate, a driven plate, a plurality of urging elements and a rotating shaft, characterized in that a plate face, formed from stacking the securing plate and the driven plate, is provided with a cam block at the center thereof, the center of the plate face is provided with a shaft hole allowing the insertion of the rotating shaft so as to mount the plate center of the securing plate and the driven plate, the external surrounding of the plate face is evenly mounted with a plurality of vertically extended urging elements having a thickness thinner than that of the cam block, the two lateral wall of a container having pivotal points are provided with an engaging hole for engaging with the cam block of the securing plate and the container having a lifting cover provided with two lateral wall corresponding to the urging element are designed with a mounting hole, and the pivot point at the two lateral wall of the lifting cover is provided with an engaging hole for mounting with cam block of the driven plate, the two lateral wall of the lifting cover corresponding to the urging element of the driven plate is provided with a mounting hole for closely mounting of the urging elements, thereby when the lifting cover is lifted up the cam block of the driven plate revolves and the movement of the cam block is restricted to an angle of lifting by the cam block of the securing plate.

Yet a further object of the present invention is to provide a pivot device for a hinged cover, wherein the urging elements mounted on the securing plate are connection screws for mounting the plate face of the securing plate, and the urging elements mounted at the driven plate face are vertically extended short pegs.

Yet a further object of the present invention is to provide a pivot device for a hinged cover, wherein the urging elements mounted at the plate face of the driven plate are connection screws mounted at the external surrounding of the driven plate and the urging elements at the securing plate face are short pegs.

The foregoing object and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is a perspective exploded view of a conventional pivotal device.

FIG. 2 is a perspective exploded view of a pivot device for a lifting cover in accordance with the present invention.

FIG. 3 is a perspective exploded view of a pivot device for a basin cover in accordance with the present invention.

FIG. 4 is a schematic view showing the cover fully covered the basin in accordance with the present invention.

FIG. 5 is a schematic view showing the basin cover of FIG. 3 fully covered the basin.

FIG. 6 is a perspective exploded view of the pivot device of another preferred embodiment in accordance with the present invention.

FIG. 7 is a schematic view showing the basin cover of FIG. 6 fully covered the basin in accordance with the present invention.

FIG. 8 is a schematic view showing the basin cover of FIG. 6 being fully lifted in accordance with the present invention.

FIG. 9 is an exploded perspective view of the pivot device of a further preferred embodiment in accordance with the present invention.

FIG. 10 is a schematic view showing the basin cover of FIG. 9 being fully closed in accordance with the present invention.

FIG. 11 is a schematic view showing the basin cover of FIG. 9 being fully opened in accordance with the present invention.

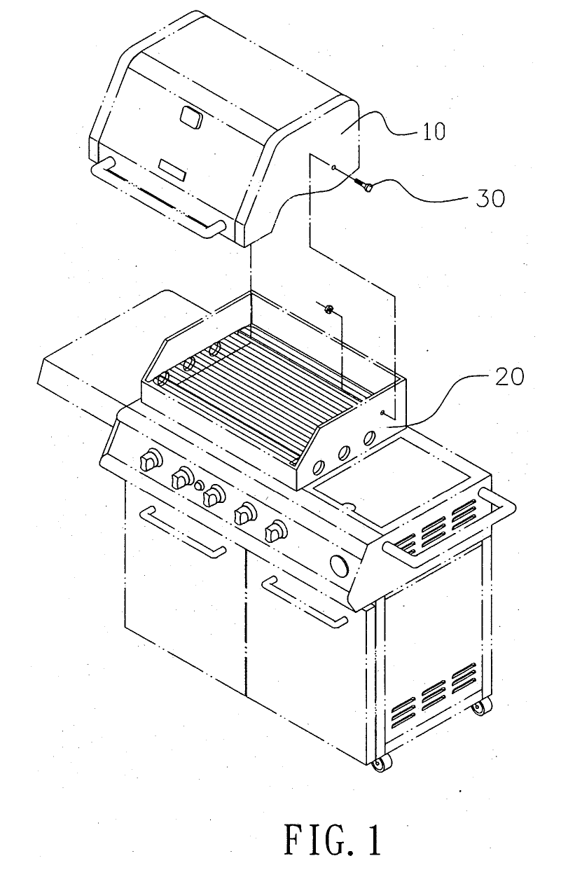

### DETAILED DESCRIPTION OF THE PREFERRED EMBODIMENT

The following descriptions are of exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

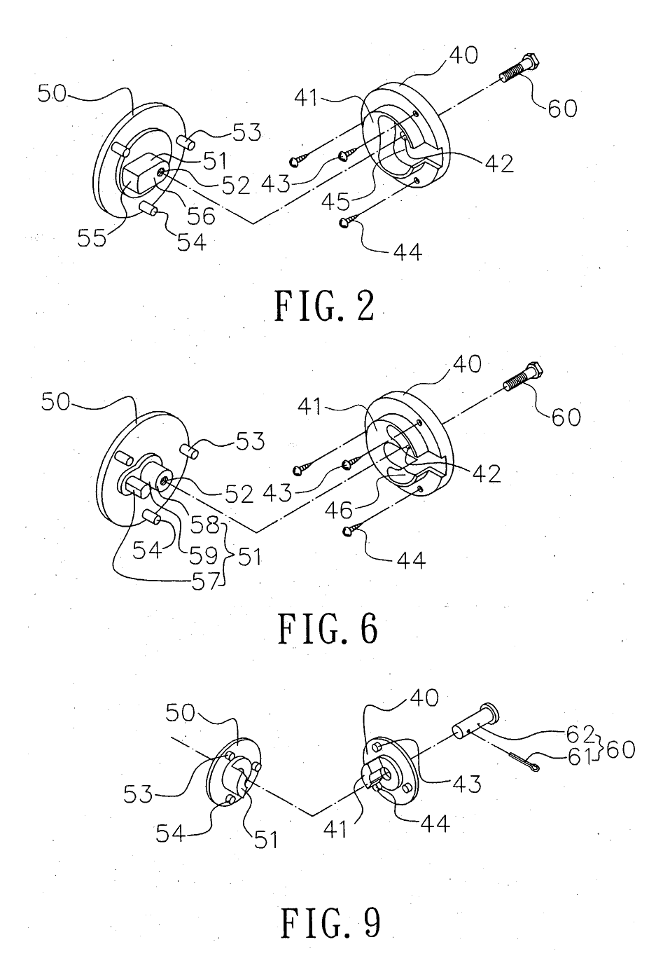

Referring to FIG. 2, there is shown an improved structure of a pivot device for mounting to the lateral wall of a cover comprising a securing plate 40, a driven plate 50, a plurality of vertically extended urging elements 43, 44, 53, 54 and a rotating shaft. A cam block 41, 51 is vertically protruded vertically from the center of the plate formed by stacking the securing plate 40 and the driven plate 50, and the cam block 41, 51 is an axle, and the center of the plate is provided with shaft hole 42, 52 for mounting with the center of the securing plate 40 and the driven plate 50. The surrounding of the plate is provided with a plurality of vertically-extended urging elements 43, 44, 53, and 54. These elements have thickness smaller than that of the cam block 41, 51. As shown in the drawing, the rotating shaft 60 is a screw with a single shaft hole 52, and the cam block 51 of the driven plate 50 is a male cam having a single protrusion 55 and a wheel abdomen 56. The cam block 41 of the securing plate 40 can be a female cam driven by the male cam containing in the sunken hole 45. The urging elements 53, 54 are vertically extended short pegs vertically mounted at the outer surrounding of the driven plate 50. The urging elements 43, 44 can be connection pegs passing through the surrounding of the securing plate 40. Due to the revolution of the plates 40, 50, which is also a relative movement, anyone of the plates 40, 50 will drive the plates 50, 40 to revolve. In the drawing, the cam body of the male cam is used as the securing plate 40, and the female cam is used as the driven plate 50, and a similar pivotal movement is obtained.

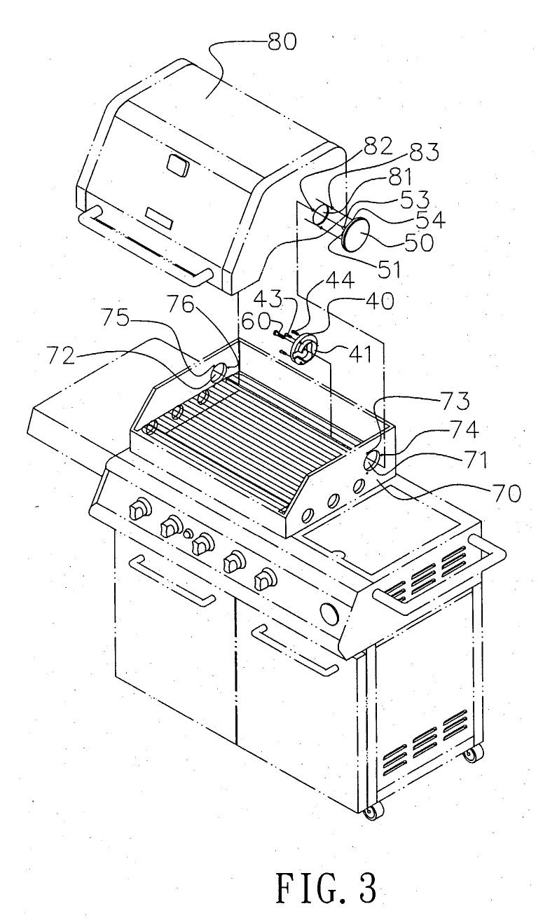

As shown in FIG. 3, the two lateral wall of a container 70 (for instance, a grille basin) are provided with engaging holes 71, 72 for mounting with the cam block 41, and the corresponding urging elements 43, 44 of the securing plate 40 are provided with mounting holes 73, 74, 75, 76 for firmly fitted to the urging element 43, 44. The pivot point at the lateral wall is provided with engaging hole 81 for mounting with the cam block 51, and the area of the two lateral wall of the lifting cover 80 engaged with the urging elements 53, 54, mounting holes 82, 83 are provided. After the wheels 40, 50 are mounted, a rotating shaft 60 is inserted through the shaft holes 42, 52.

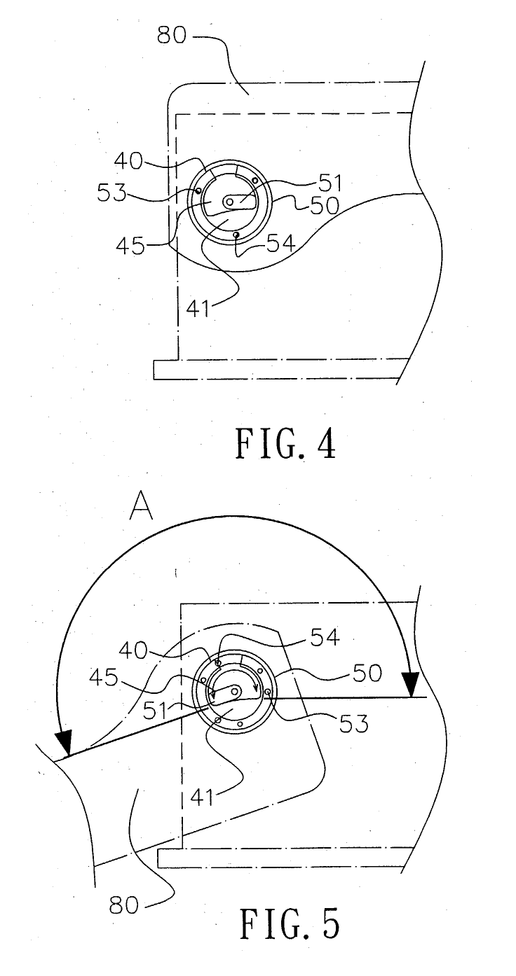

When the lifting cover 80 is lifted up, as shown in FIGS. 4 and 5, the cam block 51 of the driven plate 50 revolves as a result of the rotation of the urging elements 53, 54 and is restricted to a certain angle by the cam block 41 (the scope of angle A). As a result, the urging elements uniformly distribute the exertion force of the rotation, and the cam blocks 41, 51 have sufficient contact surface to support the rotating shear force.

FIG. 6 shows another preferred embodiment and the differences are that the cam block 51 is a male cam having one single protrusion 57 and a wheel abdomen forming a horizontal slot 59. The cam 41 is a sunken hole 46 containing the female cam driven by the male cam. The revolution movement of the plates 40, 50 is a relative movement. The cam body of the male cam is used as the securing plate 40, and the female cam is used as the driven plate, a similar pivot effect is obtained.

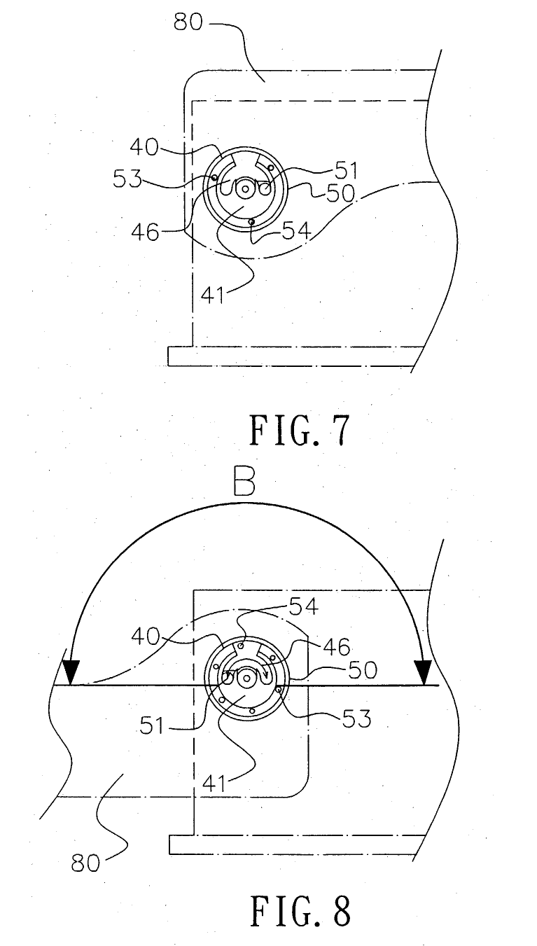

When lifting the lifting cover 80, as shown in FIGS. 7 and 8, the cam 51 revolves as a result of the driving of the urging elements 53, 54, and is restricted by the cam 41 (within the scope of angle B). The rotation of the large plate and the plurality of the urging elements evenly distribute the exertion force of the rotation. The cam 41, 51 are provided with sufficient contact face to withstand the shear force of the rotation.

FIG. 9 is another preferred embodiment and the differences of the structure are that the structure of the driven plate 50 and the securing plate 10 is the same. The cam blocks 41, 51 of the plates 40, 50 are a fan-shaped pillar block closely located to the shaft. A plurality of urging elements 43, 44, 53, 54 provided to the external surrounding of the plate can be vertically short pegs, and the rotating shaft 60 is a shaft pin 62 with a securing peg 61.

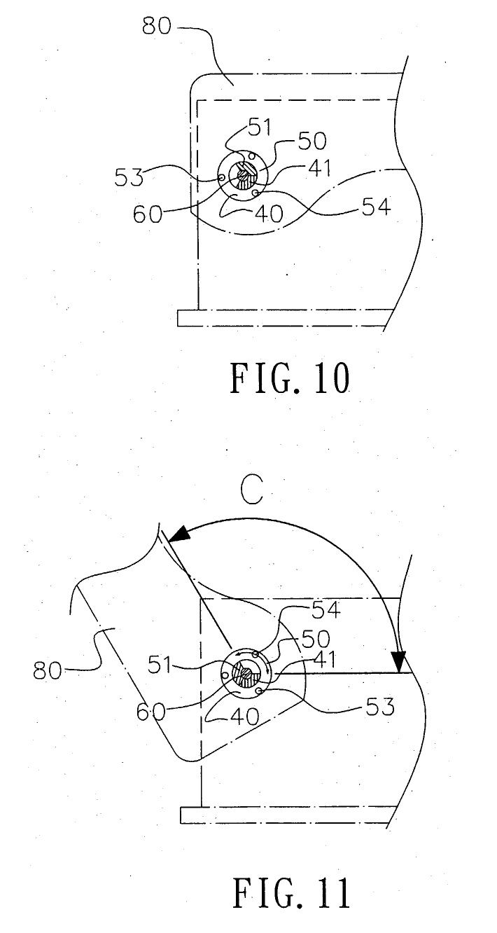

When the lifting cover 80 is to be lifted, as shown in FIGS. 10 and 11, the cam block 51 revolves as a result of the urging elements 53, 54 being driven and is restricted by the cam block 41 to an angle C. Similarly, the rotation of a large plate and the plurality of the urging elements evenly distribute the exertion force of the rotation, and the cam blocks 41, 51 are provided with contact face to withstand the shear force of the rotation.

It will be understood that each of the elements described above, or two or more together may also find a useful application in other types of methods differing from the type described above.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the spirit of the present invention.

I claim:

1. An improved structure of a pivot device for a hinged cover, having a securing plate, a driven plate, a plurality of urging elements and a rotating shaft, characterized in that a plate face formed from stacking the securing plate and the driven plate is provided with a cam block at the center thereof, the center of the plate face is provided with shaft hole allowing the insertion of the rotating shaft so as to mount the plate center of the securing plate and the driven plate, the external surrounding of the plate face is evenly mounted with a plurality of vertically extended urging elements having a thickness thinner than that of the cam block, the two lateral wall of a container having pivotal points are provided with an engaging hole for engaging with the cam block of the securing plate and the container having a lifting cover provided with two lateral wall corresponding to the urging element are provided with a mounting hole, and the pivot point at the two lateral wall of the lifting cover is provided with an engaging hole for mounting with cam block of the driven plate, the two lateral wall of the lifting cover corresponding to the urging element of the driven plate are provided with a mounting hole for closely mounting of the urging element, thereby when the lifting cover is lifted up the cam block revolves and the movement of the cam block and is restricted to an angle of lifting by the cam block of the securing plate.

2. The pivot device of claim 1, wherein the cam block of the driven plate is a male cam with a single protrusion, and the cam block of the securing plate is a female cam, mounted within a sunken hole, allowing the rotating of the male cam.

3. The pivot device of claim 1, wherein the cam block of the securing plate is a male cam with a single protrusion, and the cam block of the driven plate is a female cam, mounted within a sunken hole, allowing the rotating of the male cam.

4. The pivotal device of claim 2, wherein the male cam is an integral body having a single protrusion and a wheel abdomen.

5. The pivot device of claim 2, wherein the male cam having a separate protrusion and a wheel abdomen.

6. The pivot device of claim 1, wherein the stacked plate face of the driven plate and the securing plate are same in structure, and the cam block on the driven plate and the securing plate are pillar block closely urged against a shaft having a fan-like cross-section.

7. The pivot device of claim 1, wherein the rotating shaft is a screw used for mounting the driven plate at the shaft hole.

8. The pivot device of claim 1, wherein the rotating shaft is a shaft pin having a securing peg at the end thereof.

9. The pivot device of claim 1, wherein a plurality of vertically extended urging elements are vertically extended short pegs.

10. The pivot device of claim 1, wherein the urging elements mounted on the securing plate are connection screws for mounting the plate face of the securing plate, and the urging plate mounted at the driven plate face are vertically extended short pegs.

11. The pivot device of claim 1, wherein the urging elements mounted at the plate face of the driven plate are connection screws mounted at the external surrounding of the driven plate and the urging element at the securing plate face are short pegs.
